(19) United States
(12) Patent Application Publication
(10) Pub. No.: US 2019/0184474 A1
(43) Pub. Date: Jun. 20, 2019

(54) HOLE SAW STRUCTURE

(71) Applicant: Ting Lu YU, Changhua County (TW)

(72) Inventor: Ting Lu YU, Changhua County (TW)

(21) Appl. No.: 16/219,919

(22) Filed: Dec. 13, 2018

(30) Foreign Application Priority Data
Dec. 15, 2017 (TW) 106144261

(51) Int. Cl. B23B 51/04

(52) U.S. Cl. CPC B23B 51/0406; B23B 2251/14; B23B 2222/84; B23B 2251/40; B23B 2240/16; B23B 2251/208; B23B 2222/92

(57) ABSTRACT

A hole saw structure, which is cooperated with a hole saw arbor for performing a perforating operation, includes a cylindrical body and a blade set. The cylindrical body has a central chamber and includes an end surface and a peripheral wall. One end portion of the peripheral wall is connected around a circumference of the end surface, the other end portion of the peripheral wall is outwardly folded and overlapped around the peripheral wall so as to form a folded portion, the folded portion includes a folded end, and an inner diameter of the cylindrical body is smaller than an outer diameter of the folded portion. The blade set is disposed on the folded portion and includes at least two cutting teeth and at least two chip discharging notches.

### RELATED APPLICATIONS

This application claims priority to Taiwan Application Serial Number 106144261, filed Dec. 15, 2017, which is herein incorporated by reference.

### BACKGROUND

### Technical Field

The present disclosure relates to a hole saw structure. More particularly, the present disclosure relates to a hole saw structure which has a simple structure, a high strength and is easy to discharge chips.

### Description of Related Art

Hole saw can be used to cut a workpiece and cause a circular incision correspondingly, and then a circular opening can be formed on the workpiece corresponding to the circular incision. Therefore, the hole saw plays an important role in the manufacturing industry.

The conventional hole saw can be classified into the bi-metal hole saw and the tungsten carbide steel tooth hole saw according to the structure and manufacturing method thereof. Please refer to FIG. 1, which is a schematic view of a conventional bi-metal hole saw 10. As shown in FIG. 1, the bi-metal hole saw 10 includes a peripheral wall 11, an end surface 12 and a sawtooth 13. One end portion of the peripheral wall 11 is connected around a circumference of the end surface 12, and the sawtooth 13 is disposed on the other end portion of the peripheral wall 11 along the circumference of the peripheral wall 11. The peripheral wall 11 is made of a steel sheet by a rolling-up process and is further welded to the end surface 12, and the other end portion of the end surface 12 is turned so as to form the sawtooth 13. Therefore, the manufacturing process of the bi-metal hole saw 10 is relatively quick and simple, and the specification of the peripheral wall 11 can be adjusted according to actual needs of the size of the opening. However, because the bi-metal hole saw 10 is made of a steel sheet by the rolling-up process, the strength of the overall structure and the sawtooth 13 is insufficient. Furthermore, although the bi-metal hole saw 10 can be perfectly applied to the perforating operation of a softer workpiece such as wood or resin, the sawtooth 13 is prone to break during the perforating operation of a hard metal workpiece so as to cause the damage of the bi-metal hole saw 10. Moreover, the structure of the sawtooth 13 is not favorable for discharging the cutting chips, so that it is necessary to perform cleaning operation for several times so as to avoid the blockage of the cutting chip and affecting the efficiency of the perforating operation.

Please refer to FIG. 2, which is a schematic view of a conventional tungsten carbide steel tooth hole saw 20. As shown in FIG. 2, the tungsten carbide steel tooth hole saw 20 includes a mainbody 21, a shank body 22 and a plurality of cutting teeth 23, and a plurality of chip discharging notches 24 are disposed thereon corresponding to the cutting teeth 23. In the tungsten carbide steel tooth hole saw 20, the mainbody 21, the shank body 22 and the chip discharging notches 24 are integrally made of a metal block by a turning process, wherein the cutting teeth 23 are disposed on one side of each of the chip discharging notches 24, respectively. Therefore, the tungsten carbide steel tooth hole saw 20 made by a turning process has an overall structure with high strength, and the cutting teeth 23 are made of hard alloys such as tungsten steel or tungsten-chromium alloy, so that the tungsten carbide steel tooth hole saw 20 is favorable for applying to the perforating operation of the hard metal workpieces, such as iron sheets and steel sheets. However, the manufacturing process of the tungsten carbide steel tooth hole saw 20 made by the turning process integrally is complicated, the cost of the metal block used as the turning raw materials is high, and the size of the opening made by the tungsten carbide steel tooth hole saw 20 is also limited. Thus, the application of the tungsten carbide steel tooth hole saw 20 is not universal.

As shown above, both of the conventional bi-metal hole saw and the conventional tungsten carbide steel tooth hole saw cannot be satisfied with the demands of high strength, high chip removal efficiency and low manufacturing cost in the same time, so that the application thereof will be further limited. In order to solve the aforementioned problems, a bi-metal tungsten carbide steel tooth hole saw which combines the partial structures of the conventional bi-metal hole saw and the conventional tungsten carbide steel tooth hole saw appears in the market. Please refer to FIG. 3, which is a schematic view of a conventional bi-metal tungsten carbide steel tooth hole saw 30. As shown in FIG. 3, the bi-metal tungsten carbide steel tooth hole saw 30 includes a peripheral wall 31, an end surface 32, a plurality of cutting teeth 33 and a plurality of chip discharging notches 34, wherein the peripheral wall 31 is made of a steel sheet by a rolling-up process and further welded to the end surface 32, and the cutting teeth 33 are welded on and the chip discharging notches 34 are disposed on a side portion different from the end surface 32 of the peripheral wall 31, respectively. Therefore, the manufacturing cost of the bi-metal tungsten carbide steel tooth hole saw 30 is lower than the cost of the conventional tungsten carbide steel tooth hole saw, and the cutting ability and the chip discharging efficiency thereof can be further enhanced by the arrangement of the cutting teeth 33 and the chip discharging notches 34 compared to the conventional bi-metal hole saw. However, the structure strength of the bi-metal tungsten carbide steel tooth hole saw 30 is still far less than the structure strength of the conventional tungsten carbide steel tooth hole saw, and the damage rate thereof is quite high during the perforating operation of hard metal workpieces. Furthermore, a number of the cutting teeth 33 is also limited, so that the efficiency of the perforating operation for hard metal workpieces of the bi-metal tungsten carbide steel tooth hole saw 30 is not as well as expected.

Therefore, how to develop a hole saw structure which has a simple structure, low manufacturing cost, high strength and is easy to discharge chip has become a major aim of the people in the related business.

### SUMMARY

According to one aspect of the present disclosure, a hole saw structure, which is cooperated with a hole saw arbor for performing a perforating operation, includes a cylindrical body and a blade set. The cylindrical body has a central chamber and includes an end surface and a peripheral wall. The end surface has a central opening for connecting to the hole saw arbor. One end portion of the peripheral wall is connected around a circumference of the end surface, the other end portion of the peripheral wall is outwardly folded and overlapped around the peripheral wall so as to form a folded portion, the folded portion includes a folded end, and an inner diameter of the cylindrical body is smaller than an outer diameter of the folded portion. The blade set is disposed on the folded portion and includes at least two cutting teeth and at least two chip discharging notches. The at least two cutting teeth are separately disposed on the folded portion, wherein a blade tip of each of the at least two cutting teeth projects from the folded end, and there is an angle between a long axis of each of the at least two cutting teeth and a long axis of the cylindrical body. The at least two chip discharging notches are disposed around the folded portion, wherein each of the at least two chip discharging notches is correspondingly disposed on one side of each of the at least two cutting teeth.

### BRIEF DESCRIPTION OF THE DRAWINGS

The present disclosure can be more fully understood by reading the following detailed description of the embodiment, with reference made to the accompanying drawings as follows:

FIG. 1 is a schematic view of a conventional bi-metal hole saw.

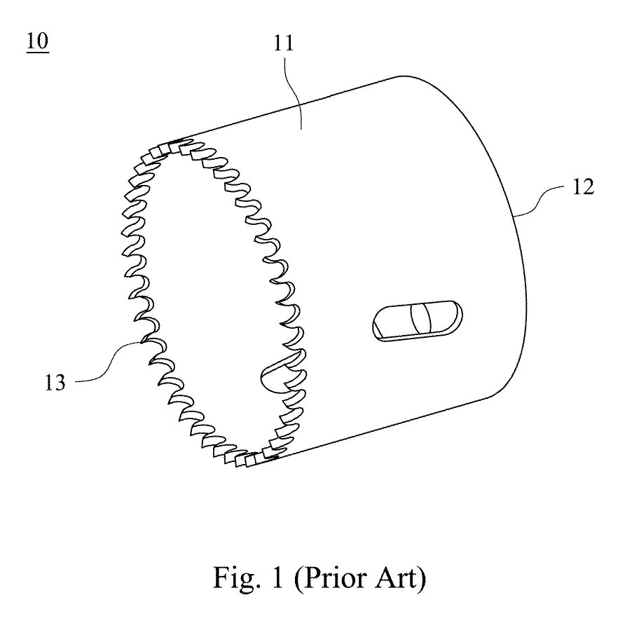

FIG. 2 is a schematic view of a conventional tungsten carbide steel tooth hole saw.

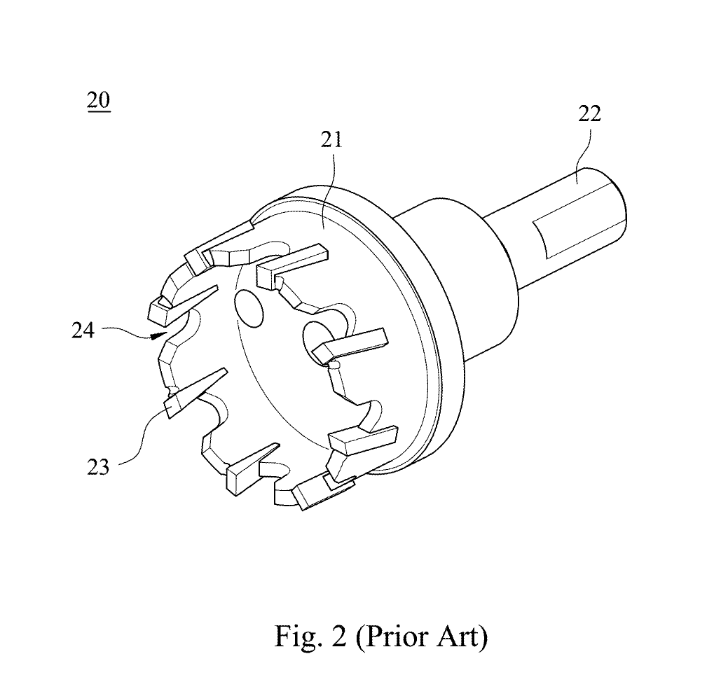

FIG. 3 is a schematic view of a conventional bi-metal tungsten carbide steel tooth hole saw.

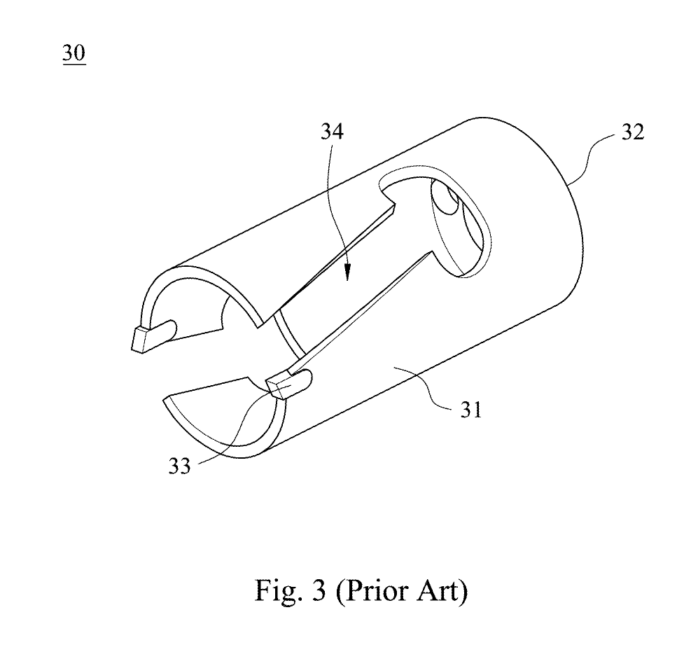

FIG. 4 is a schematic view of a hole saw structure according to the 1st embodiment of the present disclosure.

FIG. 5 is a schematic view of a blade set of the hole saw structure of FIG. 4.

FIG. 6 is a cross-sectional view of one of the cutting teeth of the hole saw structure of FIG. 4 during a perforating operation.

FIG. 7 is a schematic view of a hole saw structure according to the 2nd embodiment of the present disclosure.

FIG. 8 is a bottom schematic view of one of the cutting teeth of the hole saw structure of FIG. 7.

FIG. 9 is a partial schematic view of the hole saw structure of FIG. 7 during the perforating operation.

FIG. 10 is a schematic view of a hole saw structure according to the 3rd embodiment of the present disclosure.

FIG. 11 is a schematic view of a hole saw structure according to the 4th embodiment of the present disclosure.

FIG. 12 is a schematic view of a blade set of the hole saw structure of FIG. 11.

FIG. 13 is a bottom schematic view of one of the cutting teeth of the hole saw structure of FIG. 11.

FIG. 14 is a bottom schematic view of the hole saw structure of FIG. 11.

FIG. 15 is a partial schematic view of the hole saw structure of FIG. 11 during the perforating operation.

FIG. 16 is a schematic view of a hole saw structure according to the 5th embodiment of the present disclosure.

FIG. 17 is a bottom schematic view of the hole saw structure of FIG. 16.

### DETAILED DESCRIPTION

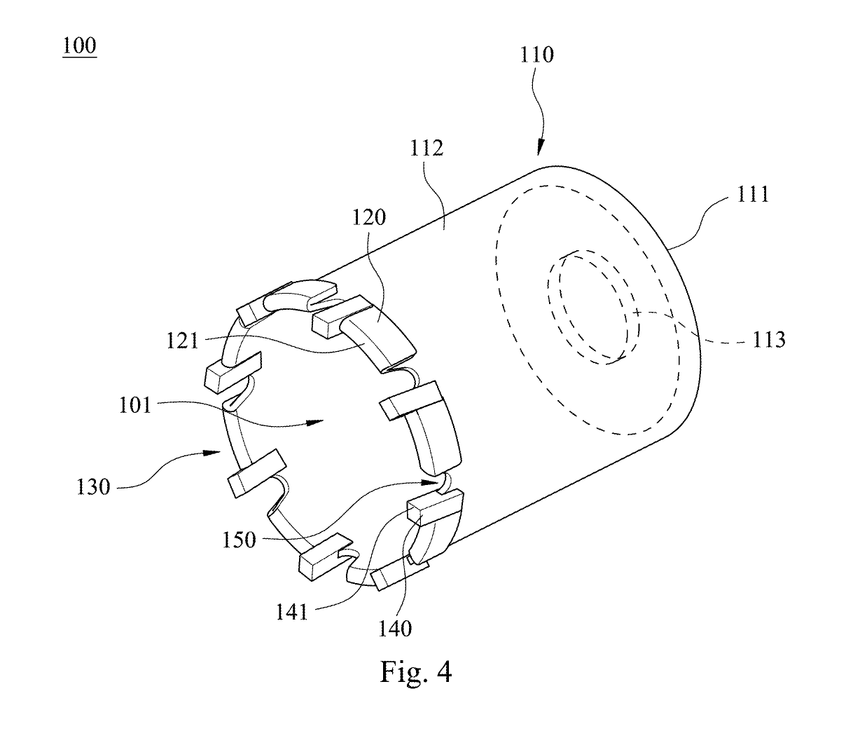

Please refer to FIG. 4, which is a schematic view of a hole saw structure 100 according to the 1st embodiment of the present disclosure. The hole saw structure 100 is cooperated with a hole saw arbor (not shown) for performing a perforating operation, and the hole saw structure 100 includes a cylindrical body 110 and a blade set 130.

The cylindrical body 110 has a central chamber 101 for accommodating the hole saw arbor, and the cylindrical body 110 includes an end surface 111 and a peripheral wall 112. The end surface 111 has a central opening 113 for connecting to the hole saw arbor. One end portion of the peripheral wall 112 is connected around a circumference of the end surface 111, the other end portion of the peripheral wall 112 is outwardly folded and overlapped around the peripheral wall 112 so as to form a folded portion 120. The folded portion 120 includes a folded end 121, and an inner diameter of the cylindrical body 110 is smaller than an outer diameter of the folded portion 120. Preferably, the folded portion 120 can be fixedly connected to the peripheral wall 112 by a welding method, a bonding method or a combination thereof, but the present disclosure is not limited thereto. Therefore, the production difficulty and the manufacturing cost of the hole saw structure 100 can be significantly reduced by the arrangement that the end surface 111 and the peripheral wall 112 are connected to each other so as to form the cylindrical body 110, so that the manufacturing efficiency of the hole saw structure 100 can be enhanced. Furthermore, the overall strength of the cylindrical body 110 can be stronger and further enhanced by the arrangement of the folded portion 120. It is favorable for preventing the efficiency of the perforating operation from affecting by the distortion and the deformation of the cylindrical body 110 which is caused by the perforating operation of the hard metal workpieces by the hole saw structure 100 cooperated with the hole saw arbor. Therefore, the application breadth and the service life of the hole saw structure 100 of the present disclosure can be further expanded.

The blade set 130 is disposed on the folded portion 120, and the blade set 130 includes at least two cutting teeth 140 and at least two chip discharging notches 150. More preferably, a number of the at least two cutting teeth 140 can be two or a multiple of two, and a number of the at least two chip discharging notches 150 can be two or a multiple of two. In detail, in the 1st embodiment of FIG. 4, the blade set 130 includes eight cutting teeth 140, and the number of the chip discharging notches 150 is eight corresponding to the number of the cutting teeth 140. The cutting teeth 140 are separately disposed on the folded portion 120, and a blade tip 141 of each of the cutting teeth 140 projects from the folded end 121. More preferably, the material of the cutting teeth 140 can be tungsten steels, tungsten-chromium alloys or other hard alloys. Therefore, the cutting teeth 140 which are separately disposed on the folded portion 120 can perform a cutting process to the workpiece evenly, and the cutting ability of the hole saw structure 100 of the present disclosure to hard metal pieces can be further enhanced by the cutting teeth 140 made of tungsten steels or other hard alloys. The chip discharging notches 150 are disposed around the folded portion 120, wherein each of the chip discharging notches 150 is correspondingly disposed on one side of each of the cutting teeth 140. Therefore, the cutting chips can be discharged outward from the central chamber 101 through the chip discharging notches 150 and removed away from the peripheral region of the blade set 130 so as to prevent the efficiency of the perforating operation of hole saw structure 100 from affecting by the accumulation of the cutting chips.

However, it must be noted that the numbers of the cutting teeth 140 and the chip discharging notches 150 can be adjusted according to actual needs, and the numbers of the cutting teeth 140 and the chip discharging notches 150 can be two, four, six, ten, or set in pairs, but the present disclosure is not limited thereto.

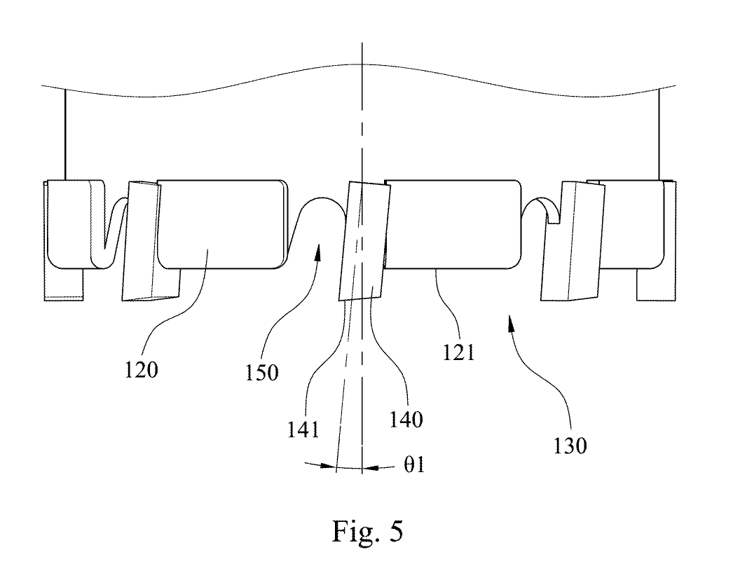

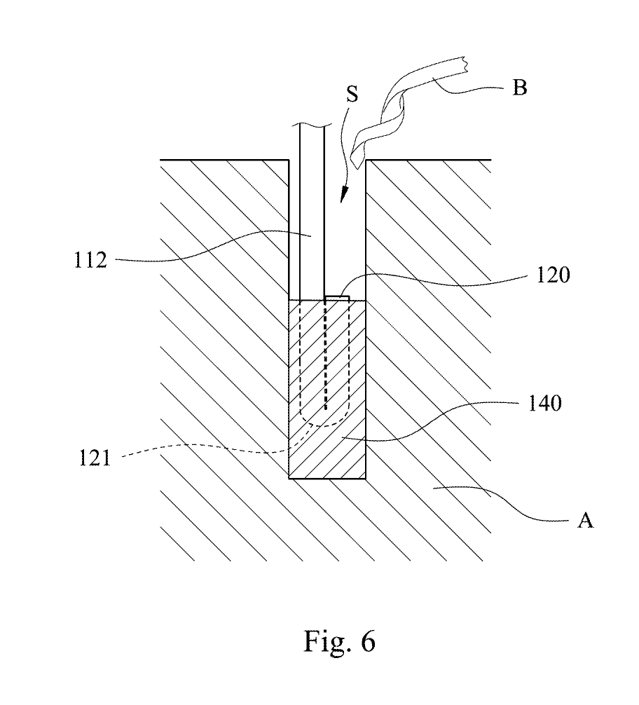

Please refer to FIG. 5 and FIG. 6, wherein FIG. 5 is a schematic view of the blade set 130 of the hole saw structure 100 of FIG. 4, and FIG. 6 is a cross-sectional view of one of the cutting teeth 140 of the hole saw structure 100 of FIG. 4 during the perforating operation. As shown in FIG. 5, a shape of the blade tip 141 of each of the cutting teeth 140 is a flat-convex shape, the cutting teeth 140 are separated from each other and equidistantly disposed on the folded portion 120, and the chip discharging notches 150 are also equidistantly disposed on one side of each of the cutting teeth 140, respectively. There is an angle θ1 between a long axis of each of the cutting teeth 140 and a long axis of the cylindrical body 110, wherein the angle θ1 can be 1° to 5°. More preferably, in the 1st embodiment of FIG. 5, the angle θ1 is 5°, but the present disclosure is not limited thereto. Therefore, it is favorable for performing the perforating operation to a workpiece by the cutting teeth 140 under a proper range of the angle θ1, and the wear on the cutting teeth 140 caused by the perforating operation can be reduced. Thus, the service time of the hole saw structure 100 can be further extended. Furthermore, in the 1st embodiment, a shape of each of the chip discharging notches 150 is upside-down U-shaped. However, although the figure is not shown, the shape of each of the chip discharging notches 150 can also be V-shaped, and the present disclosure is not limited thereto. Therefore, each of the cutting teeth 140 can provides the same cutting power to the workpiece by being disposed separately and equidistantly. It is favorable for preventing the cylindrical body 110 from being distorted or deformed or preventing the cutting teeth 140 from falling off caused by the uneven force to the hole saw structure 100 during the perforating operation, so that the cutting efficiency of the hole saw structure 100 can be further enhanced. Furthermore, by the chip discharging notches 150 which are disposed separately and equidistantly and corresponding to the arrangement of the cutting teeth 140, the cutting chips can be discharged outward from each of the chip discharging notches 150 evenly. Therefore, it is favorable for preventing the cutting chips from being accumulated in the specific one of the chip discharging notches 150 and then affecting the work of the hole saw structure 100. Moreover, the cutting teeth 140 has the blade tip 141 being flat-convex can increase the area of contact between the cutting tooth 140 and the workpiece so as to enhance the cutting power of the hole saw structure 100.

As shown in FIG. 6, the inner diameter of the cylindrical body 110 is smaller than the outer diameter of the folded portion 120, and the cutting teeth 140 are disposed centrally on the folded portion 120 and project from the folded end 121. When the hole saw structure 100 is used to perform the perforating operation to a workpiece A, a diameter of an opening (not shown) formed on the workpiece A can be larger than the inner diameter of the cylindrical body 110, so that a chip discharging space S will exist between an inner wall of the opening and the peripheral wall 112. Thus, the cutting chip B can be discharged outward from the chip discharging space S. Therefore, it is favorable for preventing the perforating operation of the hole saw structure 100 from affecting by the accumulation of the cutting chip B, so that the efficiency of the perforating operation of the hole saw structure 100 can be enhanced.

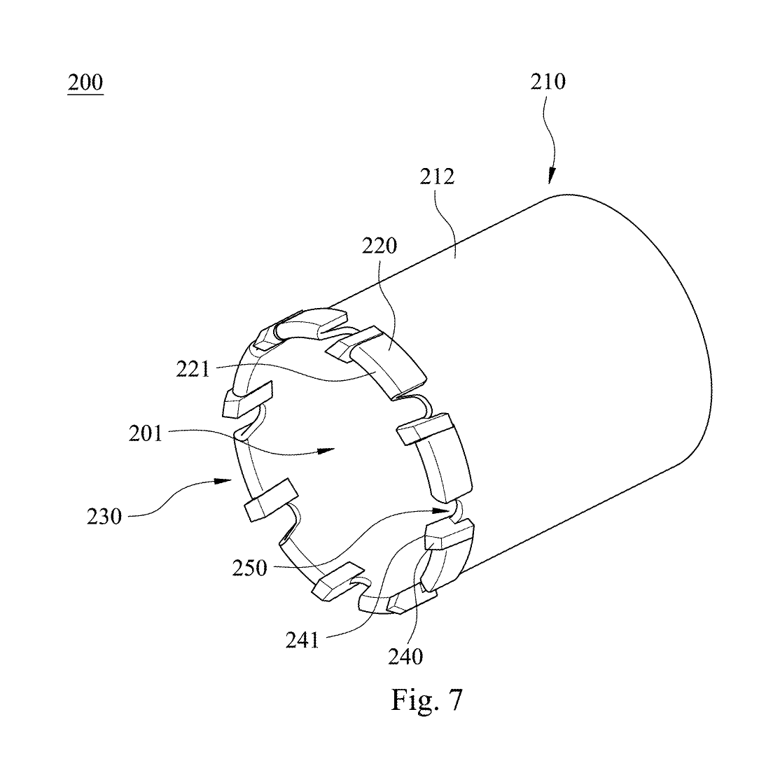

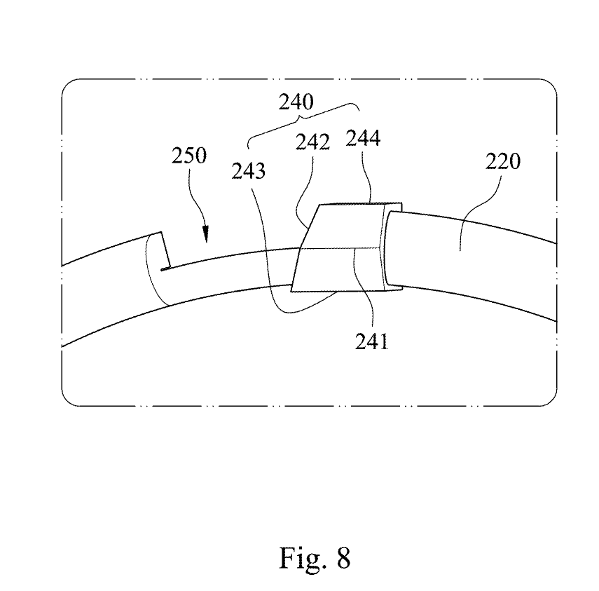

Please refer to FIG. 7 and FIG. 8, wherein FIG. 7 is a schematic view of a hole saw structure 200 according to the 2nd embodiment of the present disclosure, and FIG. 8 is a bottom schematic view of one of the cutting teeth 240 of the hole saw structure 200 of FIG. 7. The structure of the hole saw structure 200 of the 2nd embodiment is similar with the hole saw structure 100 of FIG. 4, and the detail of the same structure and elements will not be described again. The hole saw structure 200 includes a cylindrical body 210 and a blade set 230.

The cylindrical body 210 has a central chamber 201 and includes an end surface (reference number is omitted) and a peripheral wall 212. As shown in FIG. 7, the blade set 230 includes eight cutting teeth 240, and the number of the chip discharging notches 250 is eight corresponding to the number of the cutting teeth 240, but the present disclosure is not limited thereto. In the 2nd embodiment, a blade tip 241 of each of the cutting teeth 240 projects from the folded end 221, a shape of the blade tip 241 of each of the cutting teeth 240 is a sharp-convex shape, the cutting teeth 240 are separated from each other and equidistantly disposed on the folded portion 220, and each of the chip discharging notches 250 is correspondingly disposed on one side of each of the cutting teeth 240. Therefore, the hole saw structure 200 can be positioned on the workpiece first by the blade tip 241 being sharp-convex before the perforating operation so as to prevent the hole saw structure 200 from displacing in the primary period of the perforating operation and then affecting the efficiency thereof.

As shown in FIG. 7 and FIG. 8, each of the cutting teeth 140 of the hole saw structure 200 includes a front blade surface 242, an inner annular surface 243 and an outer annular surface 244. A width of the inner annular surface 243 is larger than a width of the outer annular surface 244, so that the front blade surface 242 is tilting from the central chamber 201 toward the outer annular surface 244. Therefore, the cutting chips generated from the perforating operation of the hole saw structure 200 can be discharged outward from the chip discharging notches 150 along the front blade surfaces 242 which is tilting disposed so as to prevent the efficiency of the perforating operation of hole saw structure 200 from affecting by the accumulation of the cutting chips.

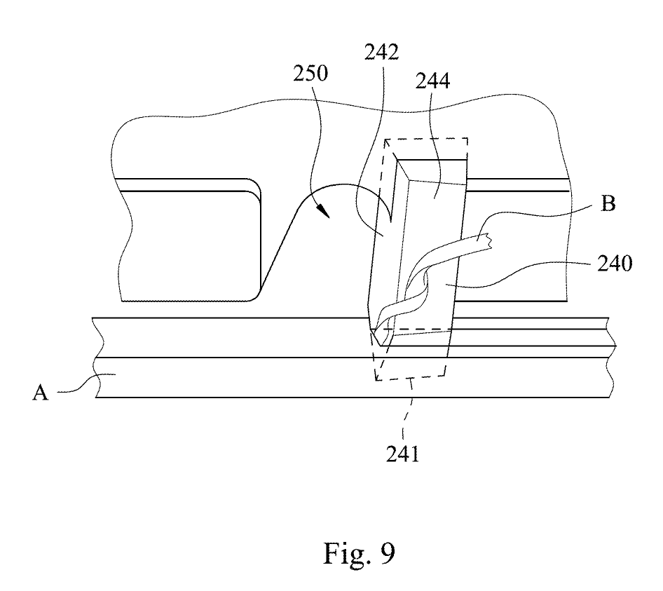

Please refer to FIG. 9, which is a partial schematic view of the hole saw structure 200 of FIG. 7 during the perforating operation. As shown in FIG. 9, when the hole saw structure 200 is used to perform the perforating operation to a workpiece A, the blade tip 241 of each of the cutting teeth 240 will contact with the surface of the workpiece A directly, and the blade tip 241 being sharp-convex will be positioned on the workpiece A and then performed the cutting process, and a cutting chip B will be produced correspondingly. Then, the cutting chip B will flip toward the outer annular surface 244 due to the front blade surface 242 which is tilting disposed and will be further discharged outward from the chip discharging notches 250. Therefore, by the front blade surface 242 which is tilting disposed, it is favorable for discharging the cutting chip B outward from the hole saw structure 200 along the tilting direction of the front blade surface 242, and the cutting resistance caused by the accumulation of a plurality of the cutting chip B can also be reduced. Thus, the times of the cleaning operation of the cutting chip can be reduced, so that the efficiency and the speed of the perforating operation of the hole saw structure 200 can be further enhanced.

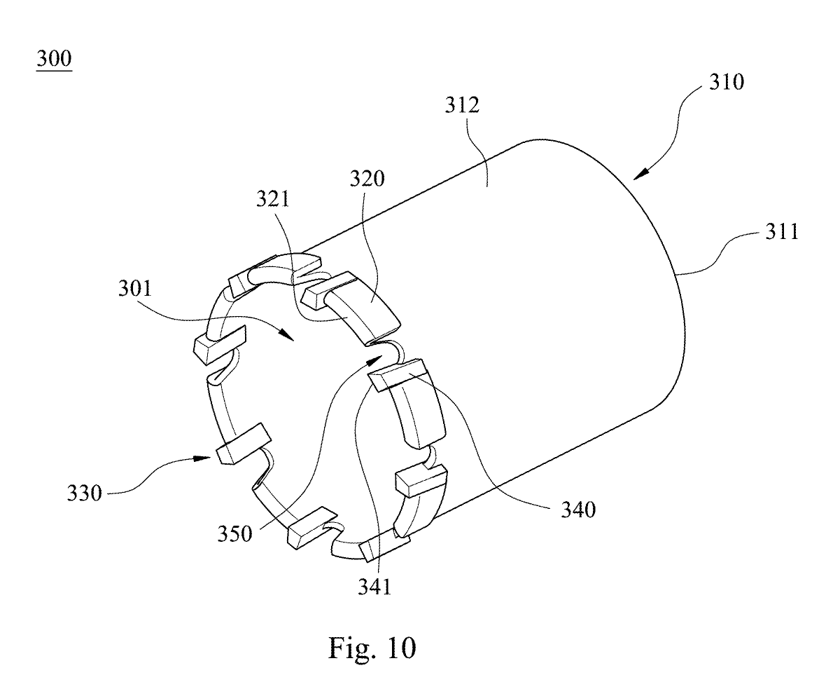

Please refer to FIG. 10, which is a schematic view of a hole saw structure 300 according to the 3rd embodiment of the present disclosure. The structure of the hole saw structure 300 of the 3rd embodiment is similar with the hole saw structure 200 of FIG. 7, and the detail of the same structure and elements will not be described again. The hole saw structure 300 includes a cylindrical body 310 and a blade set 330.

The cylindrical body 310 has a central chamber 301 and includes an end surface 311 and a peripheral wall 312. As shown in FIG. 10, the blade set 330 includes eight cutting teeth 340, and the number of the chip discharging notches 350 is eight corresponding to the number of the cutting teeth 340, but the present disclosure is not limited thereto. The cutting teeth 340 are separated from each other and equidistantly disposed on the folded portion 320, and a blade tip 341 of each of the cutting teeth 340 projects from the folded end 320. In the 3rd embodiment, a shape of the blade tip 341 of each of the cutting teeth 340 is a flat-convex shape, and a front blade surface (reference number is omitted) of each of the cutting teeth 340 is tilting disposed. Therefore, an area of contact between each of the cutting teeth 340 and the workpiece (not shown) can be increase by the blade tips 341 of the cutting teeth 340 being flat-convex, so that the cutting power of the cutting teeth 340 can be increased. Furthermore, by the front blade surface which is it is tilting disposed, the discharging efficiency of the cutting chips can be enhanced, so that the cutting power of the hole saw structure 300 to a hard workpiece can be significantly increased.

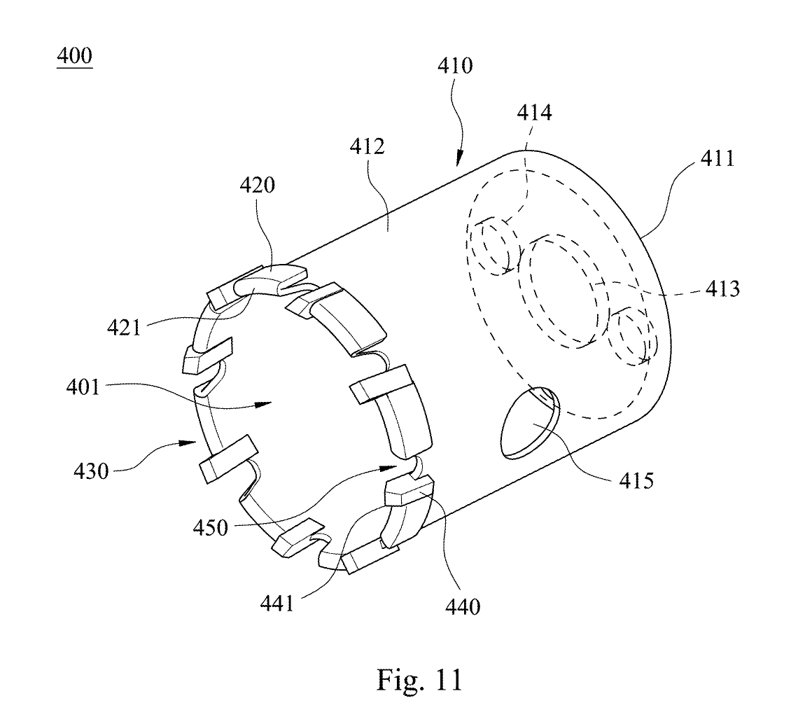

Please refer to FIG. 11, which is a schematic view of a hole saw structure 400 according to the 4th embodiment of the present disclosure. The hole saw structure 400 is cooperated with a hole saw arbor (not shown) for performing a perforating operation, and the hole saw structure 400 includes a cylindrical body 410 and a blade set 430.

The cylindrical body 410 has a central chamber 401 for accommodating the hole saw arbor, and the cylindrical body 410 includes an end surface 411 and a peripheral wall 412. The end surface 411 has a central opening 413 and at least two limiting holes 414 for connecting to the hole saw arbor correspondingly. One end portion of the peripheral wall 412 is connected around a circumference of the end surface 411, the peripheral wall 412 includes at least two chip discharging holes 415, and the at least two chip discharging holes 415 are corresponding to each other. The chips of the workpiece can be removed quickly outward from the central chamber 401 by the arrangement of the chip discharging holes 415 after finishing the perforating operation of the hole saw structure 400. Therefore, it is favorable for simplifying the preparation procedure between different perforating operations of the hole saw structure 400. The other end portion of the peripheral wall is 412 is outwardly folded and overlapped around the peripheral wall 412 so as to form a folded portion 420. The folded portion 420 includes a folded end 421, and an inner diameter of the cylindrical body 410 is smaller than an outer diameter of the folded portion 420. Preferably, the folded portion 420 can be fixedly connected to the peripheral wall 412 by a welding method, a bonding method or a combination thereof, but the present disclosure is not limited thereto. Therefore, the production difficulty and the manufacturing cost of the hole saw structure 400 can be significantly reduced by the arrangement that the end surface 411 and the peripheral wall 412 which are connected to each other so as to form the cylindrical body 410, so that the manufacturing efficiency of the hole saw structure 400 can be enhanced. Furthermore, the overall strength of the cylindrical body 410 can be stronger and further enhanced by the arrangement of the folded portion 420, so that it is favorable for preventing the efficiency of the perforating operation from affecting by the distortion and the deformation of the cylindrical body 410 which is caused by the perforating operation of the hard metal workpieces by the hole saw structure 400 cooperated with the hole saw arbor. Therefore, the application breadth and the service life of the hole saw structure 400 of the present disclosure can be further expanded.

The blade set 430 is disposed on the folded portion 420, and the blade set 430 includes at least two cutting teeth 440 and at least two chip discharging notches 450. More preferably, a number of the at least two cutting teeth 440 can be two or a multiple of two, and a number of the at least two chip discharging notches 450 can be two or a multiple of two. In detail, in the 4th embodiment of FIG. 11, the blade set 430 includes eight cutting teeth 440, and the number of the chip discharging notches 450 is eight corresponding to the number of the cutting teeth 440. The cutting teeth 440 are separately disposed on the folded portion 420, and a blade tip 441 of each of the cutting teeth 440 projects from the folded end 421. More preferably, the material of the cutting teeth 440 can be tungsten steels, tungsten-chromium alloys or other hard alloys. Therefore, the cutting teeth 440 which are separately disposed on the folded portion 420 can perform a cutting process to the workpiece evenly, and the cutting ability of the hole saw structure 400 of the present disclosure to hard metal pieces can be further enhanced by the cutting teeth 440 made of tungsten steels or other hard alloys. The chip discharging notches 450 are disposed around the folded portion 420, wherein each of the chip discharging notches 450 is correspondingly disposed on one side of each of the cutting teeth 440. Therefore, the cutting chips can be discharged outward from the central chamber 401 through the chip discharging notches 450 and removed away from the peripheral region of the blade set 430 so as to prevent the efficiency of the perforating operation of hole saw structure 400 from affecting by the accumulation of the cutting chips.

Furthermore, please refer to FIG. 11 as well as FIG. 6. The inner diameter of the cylindrical body 410 is smaller than the outer diameter of the folded portion 420, and the cutting teeth 440 are disposed centrally on the folded portion 420 and project from the folded end 421. Thus, a diameter of an opening (not shown) formed on the workpiece can be larger than the inner diameter of the cylindrical body 410, so that a chip discharging space will exist between an inner wall of the opening and the peripheral wall 412. Thus, the cutting chips can be discharged outward from the chip discharging space. Therefore, it is favorable for preventing the perforating operation of the hole saw structure 400 from affecting by the accumulation of the cutting chips, so that the efficiency of the perforating operation of the hole saw structure 400 can be enhanced.

However, it must be noted that the numbers of the cutting teeth 440 and the chip discharging notches 450 can be adjusted according to actual needs, and the numbers of the cutting teeth 440 and the chip discharging notches 450 can be two, four, six, ten, or set in pairs, but the present disclosure is not limited thereto.

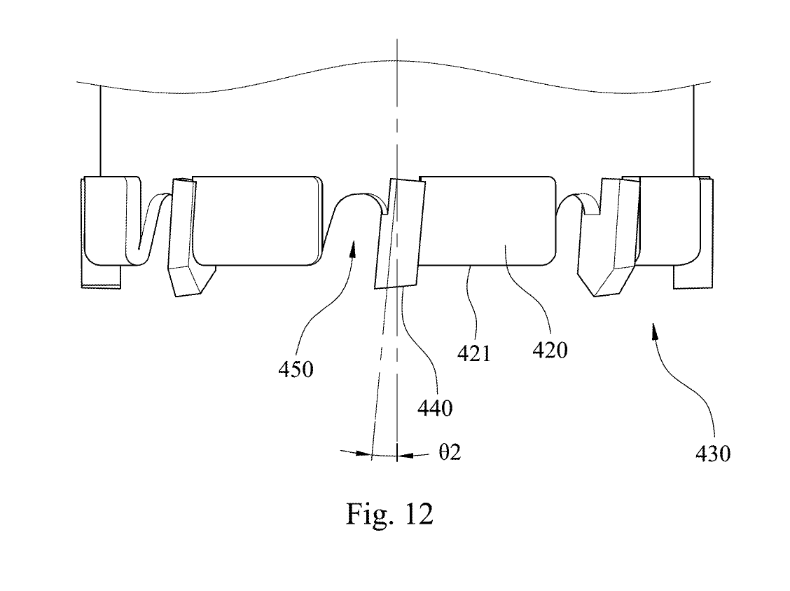

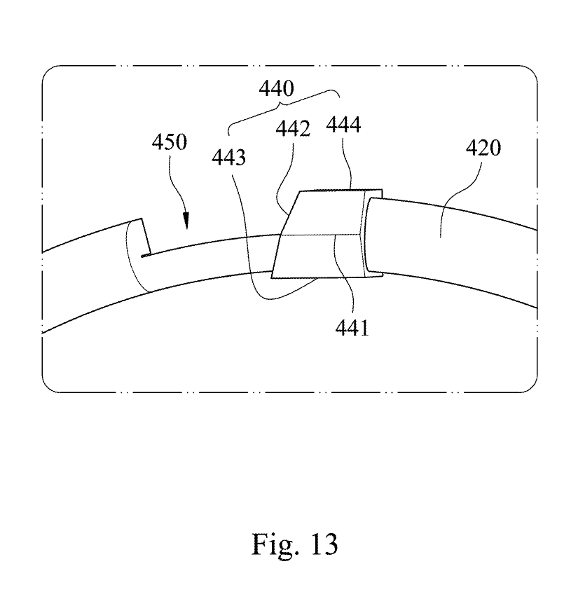

Please refer to FIG. 12 and FIG. 13, wherein FIG. 12 is a schematic view of a blade set 430 of the hole saw structure 400 of FIG. 11, and FIG. 13 is a bottom schematic view of one of the cutting teeth 440 of the hole saw structure 400 of FIG. 11. As shown in FIG. 11 to FIG. 13, the cutting teeth 440 are separated from each other and equidistantly disposed on the folded portion 420, each of the cutting teeth 440 projects from the folded end 421, and the chip discharging notches 450 are equidistantly disposed on one side of each of the cutting teeth 440, respectively. There is an angle θ2 between a long axis of each of the cutting teeth 440 a long axis of the cylindrical body 410, wherein the angle θ2 can be 1° to 5°. More preferably, in the 4th embodiment of FIG. 12, the angle θ2 is 5°, but the present disclosure is not limited thereto. Therefore, it is favorable for performing the perforating operation to a workpiece by the cutting teeth 440 under a proper range of the angle θ2, and the wear on the cutting teeth 440 caused by the perforating operation can be reduced. Thus, the service time of the hole saw structure 400 can be further extended. Furthermore, in the 4th embodiment of FIG. 12, a shape of each of the chip discharging notches 450 is upside-down U-shaped. However, although the figure is not shown, the shape of each of the chip discharging notches 450 can also be V-shaped, and the present disclosure is not limited thereto. Therefore, each of the cutting teeth 440 can provides the same cutting power to the workpiece by being disposed separately and equidistantly. It is favorable for preventing the cylindrical body 410 from being distorted or deformed or preventing the cutting teeth 440 from falling off caused by the uneven force to the hole saw structure 400 during the perforating operation, so that the cutting efficiency of the hole saw structure 400 can be further enhanced. Furthermore, by the chip discharging notches 450 which are disposed separately and equidistantly and corresponding to the arrangement of the cutting teeth 440, the cutting chips can be discharged outward from each of the chip discharging notches 450 evenly. Thus, it is favorable for preventing the cutting chips from being accumulated in the specific one of the chip discharging notches 450 and then affecting the work of the hole saw structure 400.

As shown in FIG. 11 and FIG. 13, each of the cutting teeth 440 includes a front blade surface 442, an inner annular surface 443 and an outer annular surface 444. A width of the inner annular surface 443 is larger than a width of the outer annular surface 444, so that the front blade surface 442 is tilting from the central chamber 401 toward the outer annular surface 444. When the hole saw structure 400 is used to perform the perforating operation to workpiece, the blade tip 441 of each of the cutting teeth 440 will contact with the surface of the workpiece directly, and a plurality of the cutting chips will be generated correspondingly. Then, the cutting chips will be guided to the chip discharging notches 450 and then be further discharged outward thereon due to the front blade surface 442 which is tilting disposed. Therefore, by the front blade surface 442 which is tilting disposed, it is favorable for discharging the cutting chips outward from the hole saw structure 400 along the tilting direction of the front blade surface 442, and the cutting resistance caused by the accumulation of the cutting chips can also be reduced. Thus, the times of the cleaning operation of the cutting chip can be reduced, so that the efficiency and the speed of the perforating operation of the hole saw structure 400 can be further enhanced.

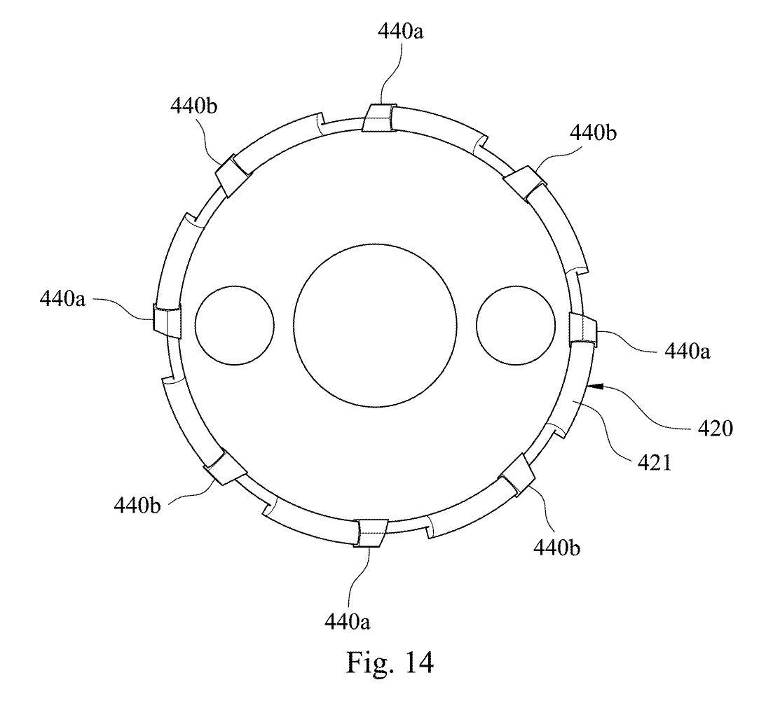

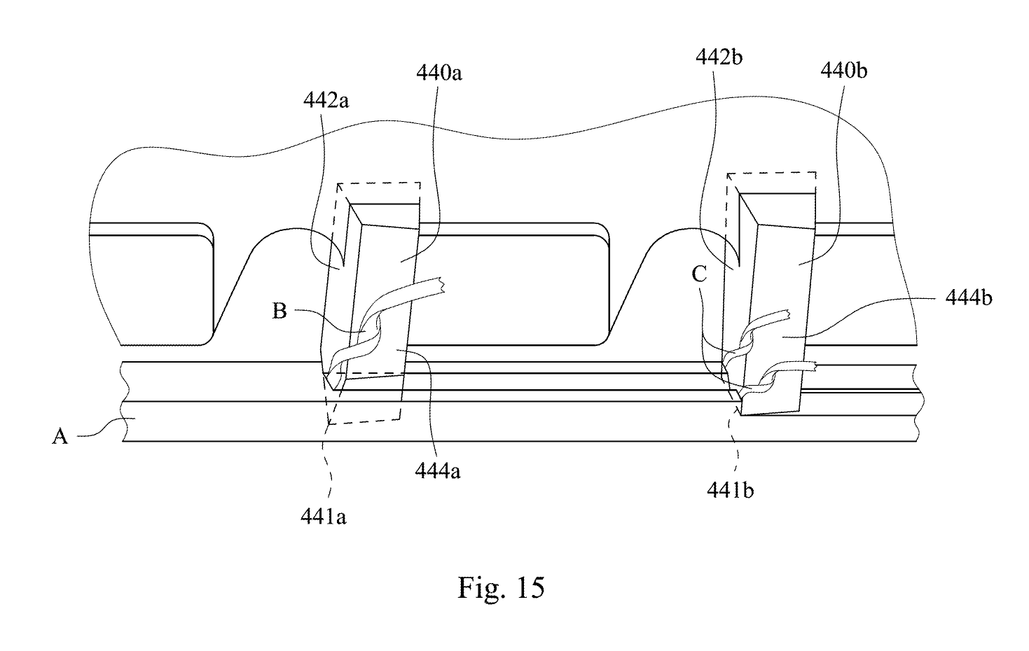

Please refer to FIG. 14 and FIG. 15, wherein FIG. 14 is a bottom schematic view of the hole saw structure 400 of FIG. 11, and FIG. 15 is a partial schematic view of the hole saw structure 400 of FIG. 11 during the perforating operation. As shown in FIG. 14, the at least two cutting teeth 440 includes a cutting teeth 440 having the blade tip 441 being sharp-convex and a cutting teeth 440 having the blade tip 441 being flat-convex, and the cutting teeth 440 having the blade tip 441 being sharp-convex and the cutting teeth 440 having the blade tip 441 being flat-convex are separated from each other and equidistantly disposed around the folded portion 420. In detail, in the 4th embodiment, the cutting teeth 440 of the hole saw structure 400 can include the cutting teeth 440a having the blade tips 441a being sharp-convex and the cutting teeth 440b having the blade tips 441b being flat-convex. The cutting teeth 440a having the blade tips 441a being sharp-convex and the cutting teeth 440b having the blade tips 441b being flat-convex are separated from each other and equidistantly disposed around the folded portion 420 and project from the folded end 421. Furthermore, as shown in FIG. 15, when the hole saw structure 400 is used to perform the perforating operation to a workpiece A, the blade tip 441a of each of the cutting teeth 440a will contact with the surface of the workpiece A directly, and the blade tip 441a being sharp-convex can position the hole saw structure 400 on the workpiece A first before performing the cutting process so as to prevent the hole saw structure 400 from displacing in the primary period of the perforating operation and then affecting the efficiency thereof. Next, the cutting teeth 440a having the blade tips 441a being sharp-convex will cut the workpiece A along a center of the cutting trace caused by the hole saw structure 400 and a cutting chip B will be generated correspondingly. The cutting chip B will flip toward the outer annular surface 444 due to the front blade surface 442 which is tilting disposed and will be further discharged outward from the chip discharging notches 450. Then, the cutting teeth 440b having the blade tip 441b being flat-convex will contact with the workpiece A and then cut the workpiece A continuously along two sides of the center of the cutting trace, wherein the cutting trace has cut by the cutting teeth 440a having the blade tips 441a being sharp-convex, and two cutting chips C will be generated correspondingly. The cutting chips C will also flip toward the outer annular surface 444 due to the front blade surface 442 which is tilting disposed and will be further discharged outward from the chip discharging notches 450. By the separately arrangement of the cutting teeth 440a having the blade tips 441a being sharp-convex and the cutting teeth 440b having the blade tips 441b being flat-convex, the hole saw structure 400 can cut the workpiece by strips along the cutting trace thereon. Therefore, a width of each of the cutting chips can be reduced, and it is favorable for discharging the cutting chips. Moreover, all of the cutting teeth 440a and the cutting teeth 440b of the hole saw structure 400 include the front blade surfaces 442 which are tilting disposed, so that not only the cutting efficiency of the hole saw structure 400 can be enhanced, but also the demand for fast chip removing can be achieved.

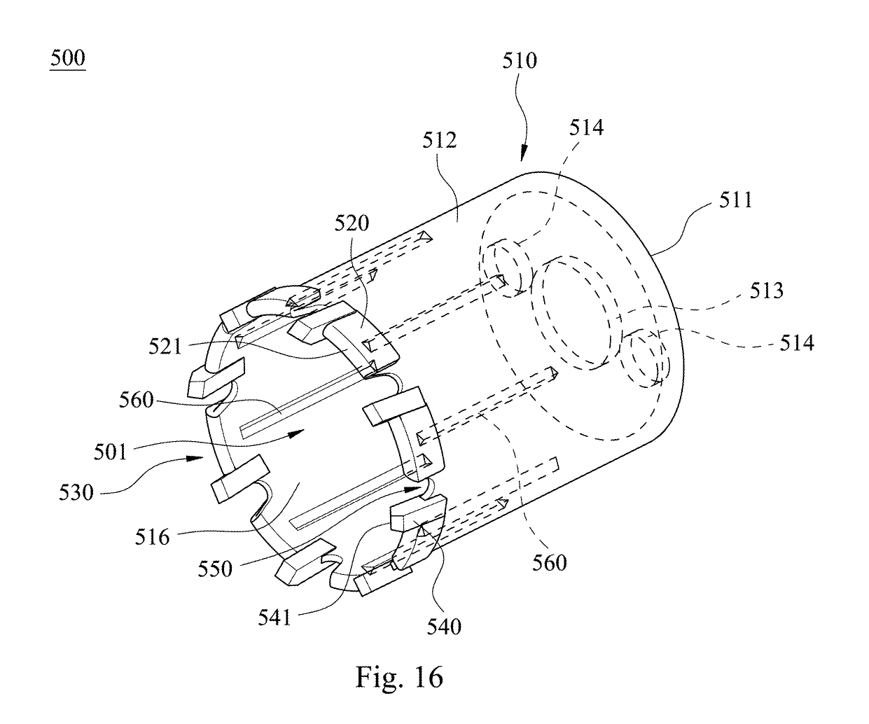

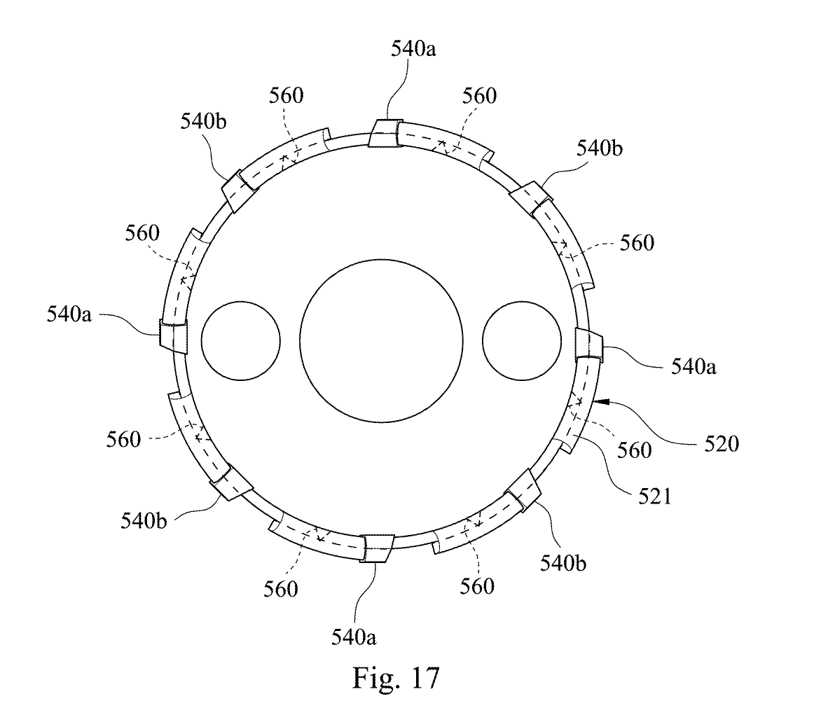

Please refer to FIG. 16 and FIG. 17, wherein FIG. 16 is a schematic view of a hole saw structure 500 according to the 5th embodiment of the present disclosure, and FIG. 17 is a bottom schematic view of the hole saw structure 500 of FIG. 16. The hole saw structure 500 is cooperated with a hole saw arbor (not shown) for performing a perforating operation, and the hole saw structure 500 includes a cylindrical body 510 and a blade set 530. The structure of the hole saw structure 500 of the 5th embodiment is similar with the hole saw structure 400 of FIG. 11, and the detail of the same structure and elements will not be described again.

The cylindrical body 510 has a central chamber 501 for accommodating the hole saw arbor, and the cylindrical body 510 includes an end surface 511 and a peripheral wall 512. The end surface 511 has a central opening 513 and two limiting holes 514 for connecting to the hole saw arbor correspondingly. One end portion of the peripheral wall 512 is connected around a circumference of the end surface 511. The peripheral wall 512 includes two chip discharging holes 515, and the two chip discharging holes 515 are corresponding to each other. The other end portion of the peripheral wall 512 is outwardly folded and overlapped around the peripheral wall 512 so as to form a folded portion 520. The folded portion 520 includes a folded end 521, and an inner diameter of the cylindrical body 510 is smaller than an outer diameter of the folded portion 520. Preferably, the folded portion 520 can be fixedly connected to the peripheral wall 512 by a welding method, a bonding method or a combination thereof, but the present disclosure is not limited thereto.

The blade set 530 is disposed on the folded portion 520, and the blade set 530 includes at least two cutting teeth 540 and at least two chip discharging notches 550. More preferably, in the 5th embodiment of FIG. 16, the blade set 530 includes eight cutting teeth 540, and a number of the chip discharging notches 550 is eight corresponding to the number of the cutting teeth 540. The cutting teeth 540 are separately disposed on the folded portion 520, and a blade tip 541 of each of the cutting teeth 540 projects from the folded end 521. The chip discharging notches 550 are disposed around the folded portion 520, wherein each of the chip discharging notches 550 is correspondingly disposed on one side of each of the cutting teeth 540.

As shown in FIG. 16 and FIG. 17, the cutting teeth 540 of the hole saw structure 500 includes the cutting teeth 540a having the blade tips 541a being sharp-convex and the cutting teeth 540b having the blade tips 541b being flat-convex. The cutting teeth 440a having the blade tips 541a being sharp-convex and the cutting teeth 540b having the blade tips 541b being flat-convex are separated from each other and equidistantly disposed on the folded portion 520 and project from the folded end 521. Therefore, the cutting efficiency of the hole saw structure 500 can be further enhanced.

In the 5th embodiment of FIG. 16, the cylindrical body 510 can further include an inner peripheral surface 516 and at least two grooves 560. The inner peripheral surface 516 is disposed on the peripheral wall 512 and surrounds the central chamber 501. The at least two grooves 560 are disposed on the inner peripheral surface 516, wherein each of the grooves 560 is disposed between one of the at least two cutting teeth 540 and one of the at least two chip discharging notches 550. More preferably, in the 5th embodiment of FIG. 16, a number of the at least two grooves 560 is eight, a length of each of the grooves 560 is equal to or larger than one half of a length of the peripheral wall 512 perpendicular to the end surface 511, each of the grooves 560 is equidistantly disposed between one of the at least two cutting teeth 540 and one of the at least two chip discharging notches 550, and a shape of each of the grooves 560 can be triangular groove-shaped or circular groove-shaped, but the present disclosure is not limited thereto.

More preferably, in the 5th embodiment of FIG. 16, each of the grooves 560 is formed by a debossing method. In detail, when the grooves 560 are made by the debossing method, parts of the inner peripheral surface 516 of the peripheral wall 512 will become concave and embed into the folded portion 520, so that the folded portion 520 can be further positioned and engaged by the grooves 560. Therefore, it is favorable for enhancing the strength of the folded portion 520 fixedly disposed on the peripheral wall 512. Furthermore, because the grooves 560 are made by the debossing method, bending structures perpendicular to the end surface 511 will be formed on the peripheral wall 512 corresponding to the arrangement of the grooves 560. Thus, the rigidity of the cylindrical body 510 can be effectively increased, and the overall strength of the hole saw structure 500 can be greatly improved. Moreover, because the overall strength of the hole saw structure 500 can be improved after the arrangement of the grooves 560, a sheet thickness of the peripheral wall 512 can be selectively reduced under the premise that the cylindrical body 510 has high degrees of rigidity and strength. In the case that the sheet thickness of the peripheral wall 512 is reduced, a thickness of each of the cutting teeth 540 perpendicular to the peripheral wall 512 (that is, a distance between the inner annular surface 443 and the outer annular surface 444 as shown in FIG. 13) can be reduced correspondingly. Therefore, the cutting resistance of the hole saw structure 500 can be reduced, and the cutting speed can be further improved.

Therefore, by the arrangement of the folded portion 520 and the grooves 560, the overall structure of the cylindrical body 510 can be stronger, and the rigidity of the hole saw structure 500 can be increased. It is favorable for preventing the efficiency of the perforating operation of the hole saw structure 500 from affecting by the distortion and the deformation thereof, and the application breadth and the service life of the hole saw structure 500 of the present disclosure can be further expanded.

According to the aforementioned embodiments, the present disclosure has the following advantages. First, the hole saw structure of the present disclosure has a simple structure by the arrangement of the folded portion, and the overall structure thereof can be further enhanced. Therefore, the hole saw structure of the present disclosure is suitable for applying to the perforating operation of hard metal workpieces, and the manufacturing cost of the hole saw structure can be significantly reduced and the cutting efficiency thereof can be further enhanced. Second, by the cutting teeth which are separated from each other and equidistantly disposed on the folded portion, each of the cutting teeth can provides the same cutting power to the workpiece. Therefore, it is favorable for preventing the cylindrical body from being distorted or deformed or preventing the cutting teeth from falling off caused by the uneven force to the hole saw structure during the perforating operation. Thus, the cutting efficiency of the hole saw structure can be further enhanced, and the service time thereof can be further increased. Third, by the arrangement of the chip discharging notches and the front blade surface being tilting, the cutting chips can be discharged outward from the hole saw structure along the tilting direction of the front blade surface. Therefore, the times of the cleaning operation of the cutting chip can be reduced, so that the efficiency and the speed of the perforating operation of the hole saw structure can be further enhanced. Fourth, by the arrangement of the cutting teeth with different types of blade tips, the hole saw structure can cut the workpiece by strips. Therefore, a width of each of the cutting chips can be reduced, so that not only the cutting efficiency of the hole saw structure can be enhanced, but also the demand for fast chip removing can be achieved. Fifth, by the grooves disposed on the inner peripheral surface, the rigidity of the cylindrical body can be significantly increased, and the overall strength of the hole saw structure can be significantly enhanced.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A hole saw structure, which is cooperated with a hole saw arbor for performing a perforating operation, comprising:
a cylindrical body having a central chamber and comprising:
an end surface having a central opening for connecting to the hole saw arbor;
a peripheral wall, wherein one end portion of the peripheral wall is connected around a circumference of the end surface, the other end portion of the peripheral wall is outwardly folded and overlapped around the peripheral wall so as to form a folded portion, the folded portion comprises a folded end, and an inner diameter of the cylindrical body is smaller than an outer diameter of the folded portion; and
a blade set disposed on the folded portion and comprising:
at least two cutting teeth separately disposed on the folded portion, wherein a blade tip of each of the at least two cutting teeth projects from the folded end, and there is an angle between a long axis of each of the at least two cutting teeth and a long axis of the cylindrical body; and
at least two chip discharging notches disposed around the folded portion, wherein each of the at least two chip discharging notches is correspondingly disposed on one side of each of the at least two cutting teeth.

2. The hole saw structure of claim 1, wherein the least two cutting teeth are separated from each other and equidistantly disposed on the folded portion.

3. The hole saw structure of claim 1, wherein the angle is 1° to 5°.

4. The hole saw structure of claim 1, wherein each of the at least two cutting teeth comprises a front blade surface, an inner annular surface and an outer annular surface, a width of the inner annular surface is larger than a width of the outer annular surface, so that the front blade surface is tilting from the central chamber toward the outer annular surface.

5. The hole saw structure of claim 1, wherein a shape of the blade tip of each of the at least two cutting teeth is a sharp-convex shape or a flat-convex shape.

6. The hole saw structure of claim 1, wherein the at least two cutting teeth comprises a cutting teeth having the blade tip being sharp-convex and a cutting teeth having the blade tip being flat-convex, and the cutting teeth having the blade tip being sharp-convex and the cutting teeth having the blade tip being flat-convex are separated from each other and equidistantly disposed around the folded portion.

7. The hole saw structure of claim 1, wherein a number of the cutting teeth is a multiple of two, and a number of the chip discharging notches is a multiple of two.

8. The hole saw structure of claim 1, wherein the folded portion is fixedly connected to the peripheral wall by a welding method, a bonding method or a combination thereof.

9. The hole saw structure of claim 1, wherein a shape of each of the chip discharging notches is upside-down U-shaped or V-shaped.

10. The hole saw structure of claim 1, wherein the peripheral wall further comprises at least two chip discharging holes, and the at least two chip discharging holes are corresponding to each other.

11. The hole saw structure of claim 1, wherein the end surface comprises at least two limiting holes for connecting to the hole saw arbor correspondingly.

12. The hole saw structure of claim 1, wherein the cylindrical body further comprises:
an inner peripheral surface disposed on the peripheral wall and surrounding the central chamber; and
at least two grooves disposed on the inner peripheral surface, wherein each of the grooves is disposed between one of the at least two cutting teeth and one of the at least two chip discharging notches.

13. The hole saw structure of claim 12, wherein each of the at least two grooves is equidistantly disposed between one of the at least two cutting teeth and one of the at least two chip discharging notches.

14. The hole saw structure of claim 12, wherein a length of each of the at least two grooves is equal to or larger than one half of a length of the peripheral wall perpendicular to the end surface.

15. The hole saw structure of claim 12, wherein a shape of each of the at least two grooves is triangular groove-shaped or circular groove-shaped.

16. The hole saw structure of claim 12, wherein each of the at least two grooves is formed by a debossing method.
